(19) United States
(12) Patent Application Publication
(10) Pub. No.: US 2024/0394283 A1
(43) Pub. Date: Nov. 28, 2024

(54) PHONOLOGY-CENTRIC SEARCHING

(71) Applicant: Microsoft Technology Licensing, LLC, Redmond, WA (US)

(72) Inventors: Kevin Corley WONUS, Haymarket, VA (US); Sin Yu Bonnie HO, Münster (DE)

(21) Appl. No.: 18/323,862

(22) Filed: May 25, 2023

(51) Int. Cl. G06F 16/31; G06F 40/284; G06F 40/47

(52) U.S. Cl. CPC G06F 16/319; G06F 40/284; G06F 40/47

(57) ABSTRACT

A computing system generates a phonemic index for an input token and executes an approximate matching analysis on content tokens of the inverted index database based on the phonemic index for the input token. The inverted index database includes a first inverted index corresponding to phonemic indices of the content tokens and to a first orthography and a second inverted index corresponding to phonemic variants of the content tokens and to a second orthography. The computing system returns one or more search results based on the approximate matching analysis.

### BACKGROUND

The ability to perform searches of proper names and locations using any language in a query presents many benefits and yet many challenges. For example, a user submits a Mandarin-language (e.g., Standard Mandarin Language) query of a proper noun to a database containing documents of any language. The user would benefit greatly if the search tool could interpret the proper noun query in an orthography-agnostic manner and perform fuzzy string comparisons to generate accurate search results matching the original query in an orthography-agnostic manner (e.g., without being limited to searching within the same orthography as the search query). However, the accuracy of transliterations and orthographic-based comparisons between different languages can induce inaccuracies. As a result, a user's search of a multi-language document database using the Mandarin-language query is likely to provide inadequate results without additional processing.

Phonology is the branch of linguistics that studies how languages or dialects systematically organize their sounds. The term can also refer specifically to the sound system of a particular language variety or orthography, whether at a level beneath the word (including syllable, onset and rime, articulatory gestures, articulatory features, mora, etc.) or all levels of language in which sounds are structured to convey linguistic meaning. Generally, “phonetic” relates to the study of speech overall, while “phonemic” relates to the study of specific sounds in certain languages. Accordingly, “phonetic” refers to the physiological study of speech sounds across all languages, and “phonemic” refers to the study of the specific sound distribution and how they are used within specific languages. A phoneme is a sound or a group of allophonic sounds perceived to have the same function by speakers of the language or dialect in question.

### SUMMARY

In some aspects, the techniques described herein relate to a method of searching an inverted index database for an input token of a search query, the method including: generating a phonemic index for the input token; executing an approximate matching analysis on content tokens of the inverted index database based on the phonemic index for the input token, wherein the inverted index database includes a first inverted index corresponding to phonemic indices of the content tokens and to a first orthography and a second inverted index corresponding to phonemic variants of the content tokens and to a second orthography; and returning one or more search results based on the approximate matching analysis.

In some aspects, the techniques described herein relate to a computing system for searching an inverted index database for an input token of a search query, the computing system including: one or more hardware processors; a phonemic indexer executable by the one or more hardware processors and configured to generate a phonemic index for the input token; an approximate match analyzer executable by the one or more hardware processors and configured to execute an approximate matching analysis on content tokens of the inverted index database based on the phonemic index for the input token, wherein the inverted index database includes a first inverted index corresponding to phonemic indices of the content tokens and to a first orthography and a second inverted index corresponding to phonemic variants of the content tokens and to a second orthography; and a score conditioner executable by the one or more hardware processors and configured to return one or more search results based on the approximate matching analysis.

In some aspects, the techniques described herein relate to one or more tangible processor-readable storage media embodied with instructions for executing on one or more processors and circuits of a computing device a process searching an inverted index database for an input token of a search query, the process including: generating a phonemic index for the input token; executing an approximate matching analysis on content tokens of the inverted index database based on the phonemic index for the input token, wherein the inverted index database includes a first inverted index corresponding to phonemic indices of the content tokens and to a first orthography and a second inverted index corresponding to phonemic variants of the content tokens and to a second orthography; and returning one or more search results based on the approximate matching analysis.

This summary is provided to introduce a selection of concepts in a simplified form. The concepts are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTION OF THE FIGURES

FIG. 1 illustrates an example search engine for performing searches using phonology-centric indexing.

FIG. 2 illustrates components of an example search engine using phonology-centric indexing.

FIG. 3 illustrates example operations for generating phonology-centric indices.

FIG. 4 illustrates example operations for training a neural phonemic translation machine learning model.

FIG. 5 illustrates example operations for performing searches using phonology-centric indexing.

FIG. 6 illustrates an example computing device for use in implementing the described technology.

### DETAILED DESCRIPTION

The described technology provides a solution for indexing entity names using a technique well-suited for cross-lingual operations and storage and for searching a database based on a search query without being limited on the orthography of the search query or the content of the database. There are multiple characteristics of the associated problem. First, entity names (e.g., person names, countries, companies, products, or proper nouns in general) are special types of tokens. These tokens differ from common nouns as they have few lexical relations. For example, there is neither a synonym nor an antonym for “Joe Biden.” Second, entity names in one language, especially person names, are normally transliterated (not translated) when borrowed across languages and are often referred to as “loan words.” For example, “Bill Gates” is [symbol] (pinyin: bi2er3 gai4ci2) in Chinese, which is phonemically similar in English and Chinese. As can be seen, the pronunciation tends to carry over from one language to another. Third, entity names are prone to misspellings and variation. For example, “Rosé,” a member from Blackpink (a South Korean pop music group), may be spelled as “Rose” without the accent in a search query. While these characteristics pertain to entity names, the described technology is not strictly limited to entity names and may be applied to other types of terms. Accordingly, various technical benefits (e.g., higher accuracy searches, wider-scope searches, cross-orthography searches) in search engines that perform fuzzy phonology-centric searches in which searching on entity names can be performed in a language-agnostic manner with reference to the search query and the searched database. Supporting such phonology-centric searches also reduces resource utilization as compared to performing translations and separate searches in different orthographies because multiple searches can be merged into a single search.

Most approaches to fuzzy string comparison logic are orthography-centric. They often involve addition/deletion of morphemes or character-level permutations etc., which can handle misspellings, typos, and name variants, to a certain extent. However, such techniques are not designed for fuzzy string comparison across dissimilar writing systems, such as in the context of cross-lingual search. Fuzzy matching or approximate (string) matching refers to a method that offers an improved ability to identify two elements of text, strings, or entries that are approximately similar (but are not necessarily precisely the same) and to determine a degree of closeness of two different strings, a measure of which can be represented by scores (e.g., maximal phonetic sequence scores or MPS scores) generated from an approximate matching analysis.

Accordingly, the described technology provides a phonology-centric approach that leverages a deep understanding of linguistic phonology and universalizes phoneme encoding by utilizing phonetic token transcoding for each token, including without limitation tokens representing entity names, such as proper nouns. Moreover, the described technology employs universal phonological constraints to normalize a search index using a handful of phonemic simplifications to produce multiple phonemic index representations that can be used with a variety of languages.

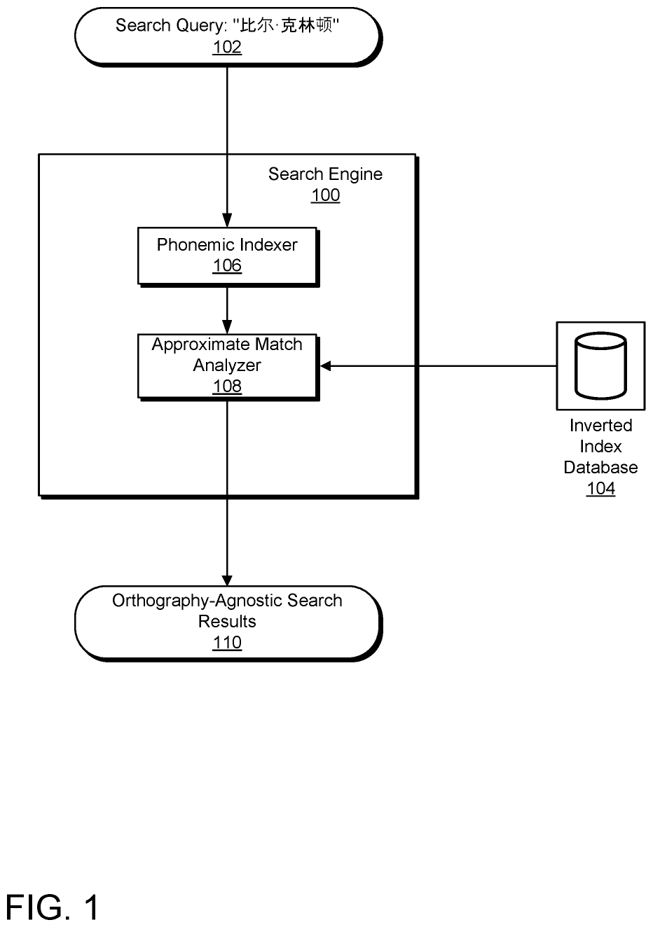

FIG. 1 illustrates an example search engine 100 for performing searches using phonology-centric indexing. As shown in FIG. 1, a search query 102 (containing an input token in the form of the Mandarin text string [symbol] ) is input to the search engine 100 for use in searching a multi-language database (e.g., a multi-orthography database), represented as an inverted index database 104 storing inverted indices referencing identified content in different orthographies. In one implementation, an inverted index data structure may be in the form of a record-level inverted index containing a list of references to content elements (e.g., documents), including each token. In another implementation, an inverted index data structure may be in the form of a word-level inverted index, which further includes the positions of each token within each content element (e.g., document). In one example, to create an inverted index, the text of each content element is first preprocessed by removing stop words, applying stemming, and using other techniques to normalize the text. The token is then added to the inverted index, where each token points to the content element in which it appears. The content itself may be stored in the same datastore as the inverted indices or in one or more separate datastores.

The inverted index database 104 includes inverted fuzzy phonemic indices (FPIs) of tokens in one or more languages, including inverted FPIs of generated variants of a token corresponding to the token's source language and/or in other languages. For example, the inverted index database 104 may include an inverted FPI of the term “Bill Clinton” as generated from English as a source language, as well as other inverted FPIs for variants of “Bill Clinton” generated from English and/or for variants of “Bill Clinton” generated from other languages, such as Mandarin. One reason for recording inverted FPIs for these variants is that the phonemic representations of “Bill Clinton” can vary slightly across different languages and even within the same language. As an example, the FPI for Bill Clinton, when generated from English, may be “p_l⋅k_l_n_t_n”, whereas the presumably matching FPI for Bill Clinton as generated from Mandarin may be “p_ [symbol] _⋅k_l_n_t_n”. Note the one-character difference between these variants, despite representing the same entity name or concept. As such, by supplementing the inverted FPIs in the inverted index database 104 with FPIs of variants, a richer set of phonemic representations can be searched for the same entity name or concept.

Such a search can involve cross-orthographic search using a phonology-centric indexing and fuzzy string comparison, a challenging operation that can nevertheless be useful in other applications as well, including, without limitation, semantic processing, spam filtering, intrusion detection, and text and speech translation between different languages. In the case of a search engine, phonology-centric indexing and fuzzy string comparison may be employed to categorize and organize data efficiently during the search. Such categorization is accomplished based at least in part on approximate string matching of the search query entity names to related keywords in the searched data.

In the search engine 100, a phonemic indexer 106 generates a fuzzy phonemic index (FPI) corresponding to the input token. The FPI functions as a lookup key that is passed to an approximate match analyzer 108, which performs a fuzzy phonemic search for the input token (using the FPI) in the inverted index database 104. The inverted index database 104 contains inverted indices containing different fuzzy phonemic variants across multiple languages. In one implementation, for example, a user may submit a search query including the token [symbol] in Mandarin, which is converted into a corresponding FPI in the form “t_ [symbol] ⋅p_t_n”. The search engine 100 then performs approximate string matching against the inverted indices from different orthography tokens in the inverted index database 104 to score approximate matches to the search query.

The approximate match analyzer 108 generates maximal phonetic sequence (MPS) scores between the FPI of the input token and the inverted indices of the searched data referenced in the inverted index database 104. The MPS scores provide a measure of how similar the input token is to a token referenced in the inverted index database 104 on a per-phoneme basis. Approximately matched documents can then be conditioned (e.g., filtered and/or ranked) based on the MPS scores and a fuzzy match condition (e.g., whether the MPS score of a search result exceeds a defined threshold). The conditioned search results can then be provided as orthography-agnostics search results 110.

In some implementations, MPS scores provide a similarity-related metric on tokens using phonetic representations and fuzzy matching. MPS scores can also be used for sorting, ranking, and/or filtering after approximate string matching is performed in a post-processing operation before presentation as search results.

MPS scores can also be used to isolate differences between two phonemic indices used in training a neural phonemic translation machine learning model. In this sense, similarities between phonemic indices are masked, emphasizing the differences between the phonemic indices. For example, when comparing “_m_n_j_l⋅m_k_ [symbol] _” (a phonemic index corresponding to Emmanuel Macron in English) with “ [symbol] _m_n_ [symbol] fsi _ [symbol] fsi _⋅m_k_l_n” (a phonemic index corresponding to Emmanuel Macron in Mandarin), three training segments are evident:
<_m ←→< [symbol] _m [where < represents the beginning of the segment]
n_j_l>←→n_ [symbol] _ [symbol] _> [where > represents the end of the segment]
k_ [symbol] >←→k_l_n> [where > represents the end of the segment]

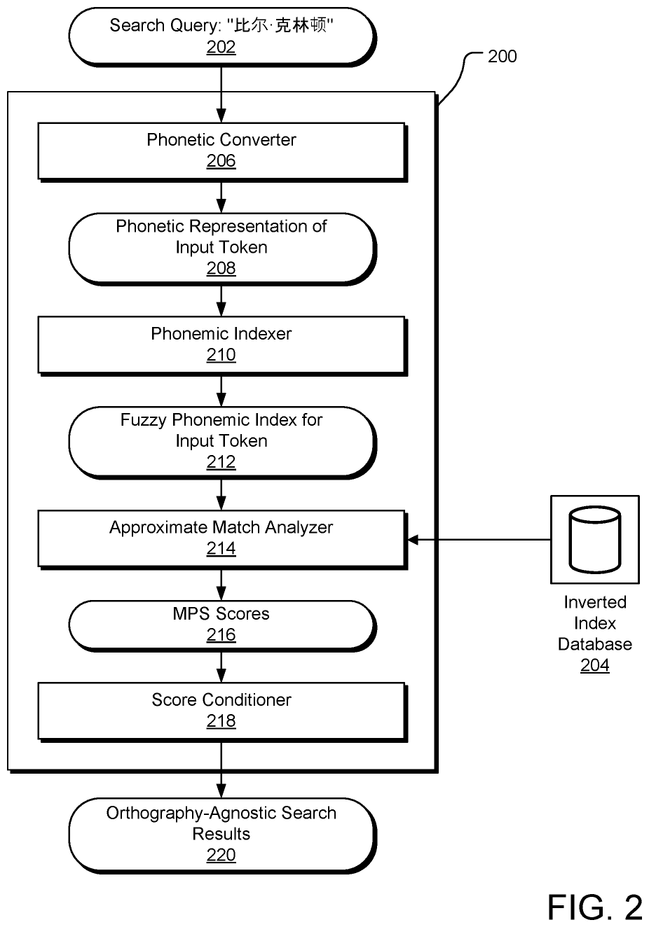

FIG. 2 illustrates components of an example search engine 200 using phonology-centric indexing. As shown in FIG. 2, a search query 202 (containing an input token in the form of the Mandarin text string [symbol] ) is input to the search engine 200 for use in searching a multi-language database, represented by an inverted index database 204.

The search query 202 is input to a phonetic converter 206 of the search engine 200, which transcribes the input token into a phonetic representation 208, such as using the International Phonetic Alphabet (IPA), the Extended SAM Phonetic Alphabet (X-SAMPA), or some other system of universal symbols that classifies sounds present in different languages around the world. Each non-diacritic character in a phonetic representation (e.g., an IPA representation) can be considered to be a phoneme. In some such systems, each symbol corresponds to a phoneme (e.g., one phonetic symbol for each sound). Phonetic conversion (e.g., phonetic transcription) is a process of transcribing words into phonetic symbols that represent the sounds of the spoken language, effectively yielding a textual representation of speech sounds.

From the phonetic representation 208 of the input token, a phonemic indexer 210 generates a fuzzy phonemic index 212 of the input token, such as by transcribing the phonetic representation 208 into a fuzzy phonemic index (FPI)—per-phoneme representation of the input token. For example, the table below presents examples of converting the raw text of input tokens into FPIs:

TABLE 1
Bill Clinton, Joe Biden, Emmanuel Macron in English

| Language | Raw Token | Phonetic | Fuzzy Phonemic |
|---|---|---|---|
| ID | Text | Representation | Index |
| English | Bill Clinton | bil · klint [symbol] n | p_l • k_l_n_t_n |
| English | Joe Biden | d [symbol] o [symbol] · baid [symbol] n | t _∫_ • p_t_n |
| English | Emmanuel | i ′ mænju [symbol] ′ • | _m_n_j_l • m_k_ [symbol] _ |
| | Macron | mæ [symbol] o [symbol] | |

Corresponding fuzzy phonemic indices for other variants (e.g., within the same orthography or in a different orthography) are generally expected to be very similar to these FPIs for the same entity name or term, enabling effective fuzzy comparison between FPIs of tokens corresponding to different orthographies. For example, the FPIs for the tokens listed above in Table 1 map closely, if not exactly, to the FPIs for the same entity names in Table 2 (each row in Table 1 corresponds to the same entity name as the same row in Table 2):

TABLE 2
Bill Clinton, Joe Biden, Emmanuel Macron in Mandarin

| Language ID | Raw Token Text | Phonetic Representation | Fuzzy Phonemic Index |
|---|---|---|---|
| Mandarin | [symbol] | pi [symbol] [symbol] • k^{h} [symbol] lintun | p_ [symbol] _•_k_l_n_t_n |
| Mandarin | [symbol] | t [symbol] ^{h}iau • pait [symbol] | t_ [symbol] _• p_t_n |
| Mandarin | [symbol] | [symbol] aimaniou [symbol] ai [symbol] [symbol] • | [symbol] _m_n_ [symbol] _ [symbol] _• |
| | | mak^{h} [symbol] lu [symbol] | m_k_l_n |

By converting the individual tokens into fuzzy phonemic indices, the similarities in the phonemic characteristics of the same entity name and the phonemic differences of different entity names are emphasized. Accordingly, while most apparent in the first row of data in each table, the FPIs of each entity name are considered more similar between the two languages of English and Mandarin than the FPIs of different entity names, thereby allowing a fuzzy similarity/difference analysis to separate the FPIs of the same entity name from those of different entity names in an orthography-agnostic manner.

In one implementation, the phonemic indexer 210 can perform one or more of the following operations when generating the index, some of which bias the resulting phonemic index toward pronunciation in a corresponding orthography, although alternative operations also be performed sequentially:
Preserving whitespace/pauses “between” name tokens (otherwise, whitespace/pauses in pronunciation are collapsed)
Deleting diacritics and tonal markings
Transcribing bilabial and labio-dental nasal consonants (e.g., [m] & [ [symbol] ]) as /m/, and other nasal consonants transcribed as /n/
Collapsing repeating clusters of identical phonemes (e.g., [mmii] becomes /mi/ for indexing purposes)
Replacing vowels & vowel clusters with a single “_” (an underscore)
Eliminating consonant clusters
   A Two-Consonant Cluster, where the two consonants are different—add “_” between the two consonants (e.g., [lp] of the term “help” becomes /l_p/).
   Two-Consonant Cluster where the two consonants are the same, such as in the phrase “big-game”—conflate the two adjacent [g-g] consonants (e.g., [g-g] becomes /g/)
   N-Consonant Cluster—remove the in-between consonants and add “_” between the first and last consonants of the cluster (e.g., [lvz] of “yourselves” becomes /l_z/)
Replacing voiced consonants with the voiceless counterparts (e.g., [d] becomes /t/ and [z] becomes /s/ in “days”; applying rules: “days” [daiz]→ /t_s/)

An approximate match analyzer 214 (also referred to as a fuzzy string searcher) accesses the inverted index database 204 to find and score approximate matches of the fuzzy phonemic index 212 (FPI) against inverted indices within the inverted index database 204. This effectively provides a random access lookup of the fuzzy phonemic index for the input token 212 through the inverted index database 204, yielding candidates for the approximate match analyzer 214. The approximate match analyzer 214 generates MPS scores 216, characterizing how close the FPI of the input token matches individual inverted FPIs stored in the inverted index database 204. In at least one implementation, the approximate match analyzer 214 removes the diacritics before computing the score.

A score conditioner 218 sorts, ranks, and/or filters matches based on the MPS scores 216 and a fuzzy match condition (e.g., whether the MPS score of a search result exceeds a defined threshold). Thereafter, the score conditioner 218 outputs some or all of the matched search results as orthography-agnostic search results 220, which can be returned in response to the search query 202, such as for presentation to a user or for supplemental processing.

MPS scores and the operation of the approximate match analyzer 214 warrant additional description. The concept of maximal phonetic sequence (MPS) is related to similarity metrics and difference metrics, which can serve the same problem domains. Yet, such metrics are directed to orthographic string similarity. MPS extends these concepts by also considering character similarity by conducting per-phoneme approximate matching.

The following represents example MPS scoring and phoneme alignment for two tokens:

| | |
|---|---|
| [symbol] | IPA: pi [symbol] · k^{h} [symbol] lintun |
| Bill Clinton | IPA: bIl klIn t [symbol] n |

Input accumulator = 0; cnt = 0

| p | i | [symbol] | [symbol] | k | [symbol] | l | i | n | t | u | n |
|---|---|---|---|---|---|---|---|---|---|---|---|
| b | I | l | k | l | I | n | t | [symbol] | n | | |

MPS:

| | | | | | | | | | | | |
|---|---|---|---|---|---|---|---|---|---|---|---|
| p | i | [symbol] | [symbol] | k | [symbol] | l | i | n | t | u | n |
| b | I | l | k | l | I | n | t | [symbol] | n | | |

Yield: accumulator += score(sequence); cnt += 6

| Left Remainder: | | | | | | Right Remainder: none/noop |
|---|---|---|---|---|---|---|
| p | i | [symbol] | [symbol] | k | [symbol] | — |
| b | I | l | k | | | — |

MPS:

| | | | | | |
|---|---|---|---|---|---|
| p | i | [symbol] | [symbol] | k | [symbol] |
| b | I | l | k | | |

Yield: accumulator += score(sequence); cnt += 2

| Left Remainder (trivial yield): none/noop | Right Remainder: | | | |
|---|---|---|---|---|
| — | [symbol] | [symbol] | k | [symbol] |
| — | l | k | | |

MPS:

| | | | |
|---|---|---|---|
| [symbol] | [symbol] | k | [symbol] |
| l | k | | |

Yield: accumulator += score(sequence); cnt += 1

| k | | |
|---|---|---|
| k | | |
| Left Remainder (trivial yield): cnt += 2 | | Right Remainder (trivial yield): cnt += 1 |
| [symbol] | [symbol] | [symbol] |
| — | — | — |

score = accumulator/cnt

Moreover, when MPS is fed a phonetic representation, phoneme similarity is controlled by the sound of each pair of phonemes rather than orthographic similarity, which can address the following:
Fuzzy indexing generates numerous false negatives
False positives and low-scoring matches are filtered-out and/or sorted to the bottom by scoring with MPS
MPS provides more precise similarity metrics than other similarity/difference approaches

In at least one implementation, the approximate match analyzer 214 implements a fuzzy comparison function, such as:

Compare (ipa1, ipa2, comparator)

where ipa1 represents an FPI of a first token (such as an input token of a search query), ipa2 represents an FPI of a second token (such as a token in a document of a multi-language database), and comparator represents the executable program code for performing an approximate match analysis and yielding an MPS score for the two tokens.

Accordingly, after vectorizing each phonetic representation of each token into phoneme embeddings, the Compare ( ) function performs a per-phoneme similarity calculation using the comparator( ) function passed in as a parameter. The phoneme embeddings for each phoneme of each token are compared for similarity using its relative position within the other string. Notwithstanding, phonemes are not simply compared via Boolean logic for equality. Instead, the embeddings that represent the two phonemes within the phonemic string are compared via the comparator function. In short, a similarity function on each phonetic representation of a phoneme with its corresponding phoneme embeddings in the other comparison string, resulting in an MPS score measuring this similarity between each phoneme pair. These per-phoneme scores are summed, and the resulting MPS score is averaged by the Compare( ) function, which takes the total summation divided by the number of candidate phonemes in the token. The phoneme comparator itself is a parameter of the Compare function. Phoneme embeddings can be deemed similar when the comparator function deems them to be similar.

One standard comparator function is cosine similarity, defined as:

$$similarity ( A , B ) = \frac{A \cdot B}{‖ A ‖ \times ‖ B ‖} = \frac{{\sum }_{\text{?} = 1}^{\text{?}} {A}_{\text{?}} \times {B}_{\text{?}}}{\sqrt{{\sum }_{\text{?} = 1}^{\text{?}} {A}_{\text{?}}^{2}} \times \sqrt{{\sum }_{i = 1}^{\text{?}} {B}_{\text{?}}^{2}}}$$

$$\text{?} \text{indicates text missing or illegible when filed}$$

By utilizing a single bit-wise integer to represent a vector, processing overhead is streamlined, obviating the need for actual arrays and thus reducing or minimizing object instantiations. This compact representation is designed to tune the performance of the approximate match analyzer 214.

Each Compare( ) invocation returns two scores:
1. Phonetic faithfulness score with relaxation neither upon phonological constraints nor upon orthographical constraints (0 to 10000)
2. Constraint-relaxation score (0 to 10000)

In some implementations, there can be two levels of comparisons in both scores:
1. character_granularity: cosine similarity (−1.0<=similarity<=1.0)//Jaccard, Cosine, or other :: normalized to 0-10000
2. string_granularity: scoring is a roll-up of character similarity per segment//mean of all character scores

The comparator is a function that provides a score that indicates the similarity between two phonemes. A phoneme is represented initially as IPA (International Phonetic Alphabet) and later as phoneme embeddings represented as arrays of bits, for example. For the sake of compactness and performance, each phoneme embedding is represented as an unsigned integer (here, the number of bits that compose the unsigned integer dictates the number of dimensions in the phoneme embeddings. As 128-bit integers are supported on modern computing systems, the number of dimensions supported in an unsigned integer is adequate to represent as many features as will be required to represent individual phonemes).

Cosine Similarity, Jaccard Similarity, or a custom comparator is passed as a Function parameter to the Compare( ) function using a dependency injection pattern. In some implementations, any similarity method can be utilized.

Pseudo-code examples for comparator( ) functions are provided below, although other implementations may be employed:

```
function CosineSimilarity(feature Vector1, feature Vector2): uint16:
  if featureVector1 = 0:
    return 0
  if feature Vector2 = 0:
    return 0
  if feature Vector1 = feature Vector2:
    return 10000
```

| | |
|---|---|
| var c = cosine(feature Vector1, feature Vector2) | # value between −1.0 and 1.0 |

```
  if c <= 0.0:
    return 0
```

| | |
|---|---|
| return c * 10000 | # normalize value into an integer between 0 and 10,000 |
| | # where 10,000 represents 1.0 [or 100% match] |

```
function Jaccard(feature Vector1, feature Vector2): uint16:
  if featureVector1 = 0
    return 0
  if featureVector2 = 0
    return 0
  if feature Vector1 = feature Vector2
    return 10000
  var size1 = sizeof(featureVector1)
  var size2 = sizeof(featureVector2)
  var size = Max(size1, size2)
  bit = 1
  both = 0
  either = 0
  for position = 1 to size:
    found = false
    if (position <= size1) and (bit & feature Vector1 = bit):
      found = true
    if (position <= size2) and (bit & feature Vector2 = bit):
      if found = true:
        both = both + 1
      found = true
    if found = true:
      either = either + 1
    bit = bit << 1 # left-shift the bit
  return (10000 * both) / either;# normalize value into an integer between 0 and 10,000
```

A description of an example approximate matching analysis (e.g., using a fuzzy-comparison algorithm) is provided. In this example: if an English token e is compared with a Chinese token c, the following steps may be executed:

### Transliterate Into IPA:

```
  e = “Bill Clinton”
  c = “ [symbol]   ”
  e_ipa = TextToIPA(e, “en”) # e_ipa = [ bIl klIn t [symbol]   n ] # language code for English =
  “en”
# e1v: [ 20000D80, 24D, 4020380, 0, 400C80, 4020380, 24D, 4001380, 0, 4000C80, 22F,
4001380 ] (hex)
  c_ipa = TextToIPA(c, “zh”) # c_ipa = [ pi [symbol]   · k^{h} [symbol]   lintun ] # language code for Chinese = “zh”
```

### Remove Diacritics and all Spacing Except for Token Boundaries:

(e.g., “Bill Clinton” has two tokens and one token boundary)

| | |
|---|---|
| ex_ipa = NormalizeAndSimplify(e_ipa) | # ex ipa = [ bIl · klInt [symbol] n ] |
| cx_ipa = NormalizeAndSimplify (c_ipa) | # cx_ipa = [ pi [symbol] · k [symbol] lintun ] |
| score = Compare(ex_ipa, cx_ipa, Jaccard) | # dependency-injection (e.g., inversion-of-control) |

to pass in per-character comparisons

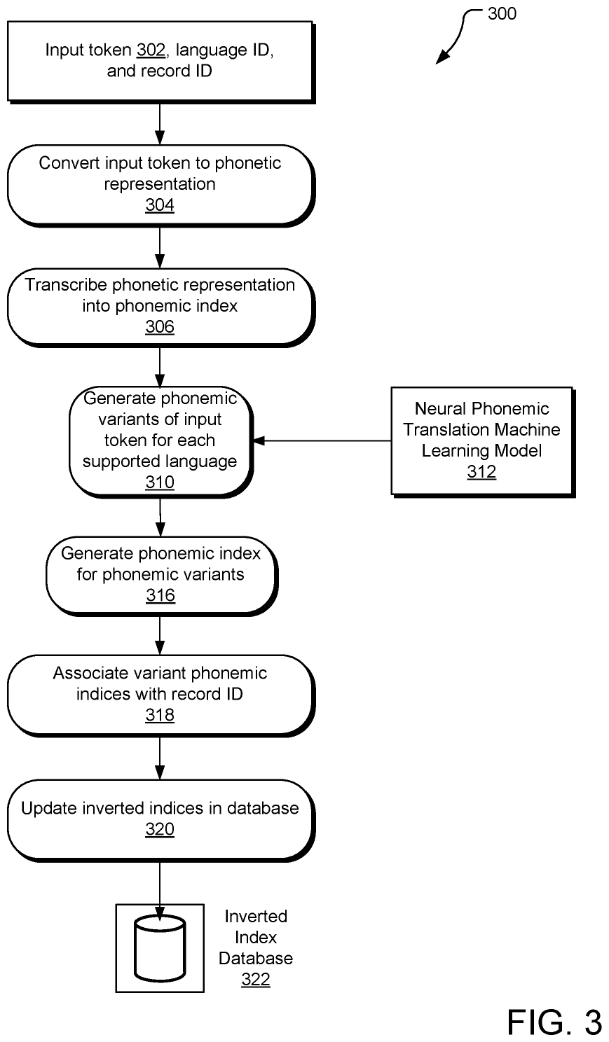

FIG. 3 illustrates example operations 300 for generating phonology-centric indices. The operations 300 present a pipeline for generating inverted indices corresponding to tokens of the searched database in multiple orthographies, and the operations 304 and 306 can also be used to generate a phonemic index for an input token of a search query. The pipeline generates a phonemic index for each input token in the orthography of the input token and can further generate phonemic indices for one or more phonemic variants of the input token in other orthographies. These phonemic indices are used as keys for inverted indices in the searched database corresponding to different orthographies.

An input token 302, a language ID, and a record ID are input to a converting operation 304, which converts the input token 302 to a phonetic representation, such as IPA. The language ID identifies the orthography of the input token record, and the record ID uniquely identifies the record itself. A transcribing operation 306 transcribes the phonetic representation of the input token 302 into a phonemic index. The phonemic index for the input token 302 is used as a key for the inverted index of the corresponding orthography.

A variant generation operation 310 generates phonemic variants for each supported language using a neural phonemic translation machine learning model 312. The neural phonemic translation machine learning model 312 is trained using known phonemic index pairs corresponding to different orthographies. The phonemic index pairs train the neural phonemic translation machine learning model 312 to generate phonemic variants of the same token, such as those shown in Tables 1 and 2. An indexing operation 316 generates phonemic indices for the input token and the phonemic variants of the input token.

Either the input token index, or the input token index and the indices for any phonemic variants, are input to an associating operation 318, which associates the index or indices with the record ID of the input token. An updating operation 320 updates the inverted indices database 322 with the information contained in the phonemic indices generated by operations 306 and 316.

The index for a search query token is input into an approximate match analyzer (e.g., a fuzzy searcher), which then finds and scores approximate matches of the index for a search query token against inverted indices within the searched database.

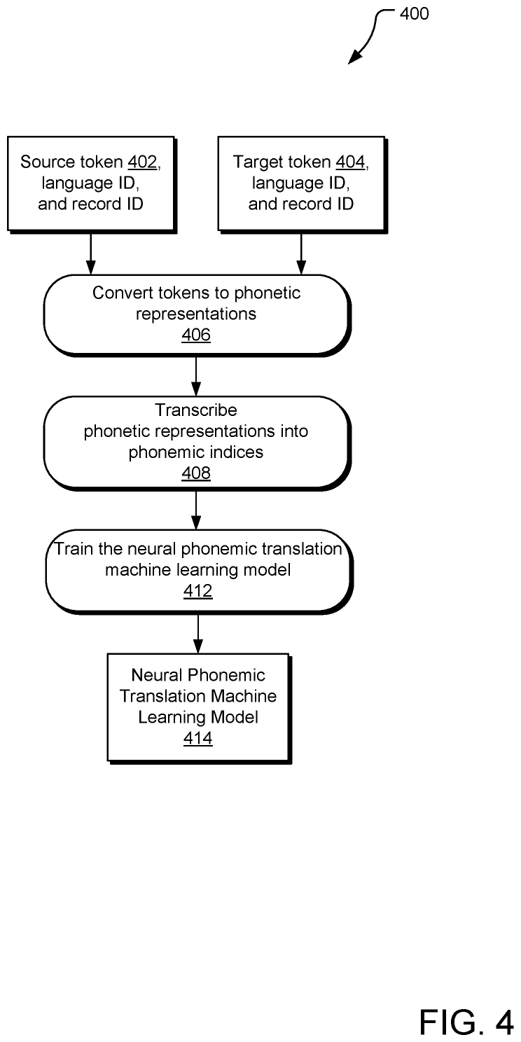

FIG. 4 illustrates example operations 400 for training a neural phonemic translation machine learning model. The training process uses known language pairs to train the neural phonemic translation machine learning model, which is configured to generate phonemic variants of an input token in an inference mode. Accordingly, a source token 402 (along with an associated language identifier and a record identifier) and a target token 404 (along with an associated language identifier and a record identifier). The source token 402 and the target token 404 are phonemic variants of each other. For example, the source token 402 may correspond to English language text (“Bill Clinton”), and the target token 404 may correspond to Mandarin language text ( [symbol] ). The language of each token is identified by a language identifier, and each token is associated with a unique record identifier to assist in the management of the various token records.

A converting operation 406 converts the source token 402 and the target token 404 into corresponding phonetic representations, such as in IPA. In some implementations, the representations may be aligned on syllable, word, and/or pause boundaries. A transcribing operation 408 transcribes the source token 402 and the target token 404 into corresponding phonemic inverted indices, such as described with regard to FIG. 3. The representations output from the transcribing operation 408 are input to a training operation 412, which trains the neural phonemic translation machine learning model 414 to generate variants of input tokens, such as described with regard to FIG. 3.

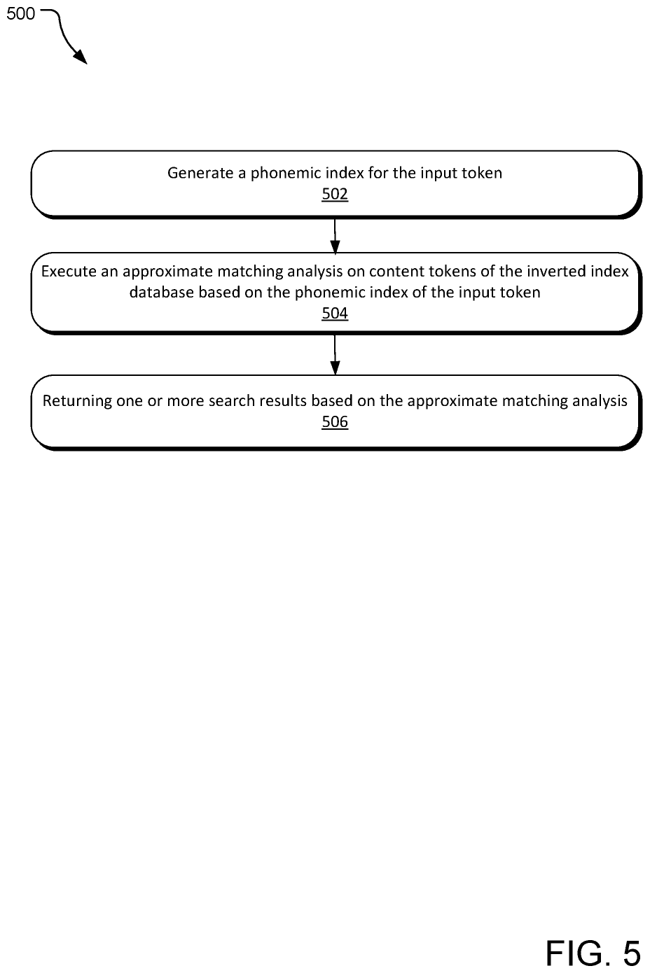

FIG. 5 illustrates example operations 500 for performing searches using phonology-centric indexing. The operations 500 present an example implementation for searching an inverted index database for an input token of a search query. A generating operation 502 generates a phonemic index for the input token. In some implementations, the generating operation 502 may include converting the input token into a phonetic representation and/or transcribing the phonetic representation of the input token into the phonemic index for the input token. For example, as part of a query, an input token in the form of the Mandarin text string [symbol] is converted into a phonetic representation (e.g., in IPA format) and then transcribed into a corresponding phonemic index “p _ [symbol] _⋅k_l_n_t_n” corresponding to Mandarin. In another example, an input token in the form of the English text string “Bill Clinton” is converted into a phonetic representation (e.g., in IPA format) and then transcribed into a corresponding phonemic index “p_l⋅k_l_n_t_n” corresponding to English. Note that the two phonemic indices are similar, but they need not be identical, as an approximate matching analysis (e.g., a “fuzzy search”) can detect and score the similarity.

An approximate matching operation 504 executes an approximate matching analysis on content tokens of the inverted index database based on the phonemic index for the input token. The inverted index database includes a first inverted index corresponding to phonemic indices of the content tokens and to a first orthography and a second inverted index corresponding to phonemic variants of the content tokens and to a second orthography. In some implementations, the approximate matching operation 504 also executes aligning positions of phonemes in the input token with the positions of corresponding phonemes in each content token, comparing phoneme embeddings corresponding to each phoneme of the input token is compared to phoneme embeddings of a corresponding phoneme of each content token, and/or generating a score for each content token based on per-phoneme similarity analysis with the input token, wherein the score represents a combination of measurements of similarity between phoneme embeddings corresponding to each phoneme of the input token is compared to phoneme embeddings of each corresponding phoneme of each content token.

A returning operation 506 returns the search results from the approximate matching operation 504. The returning operation 506 may also sort, rank, and/or filter the search results based on scores resulting from the approximate matching operation 504.

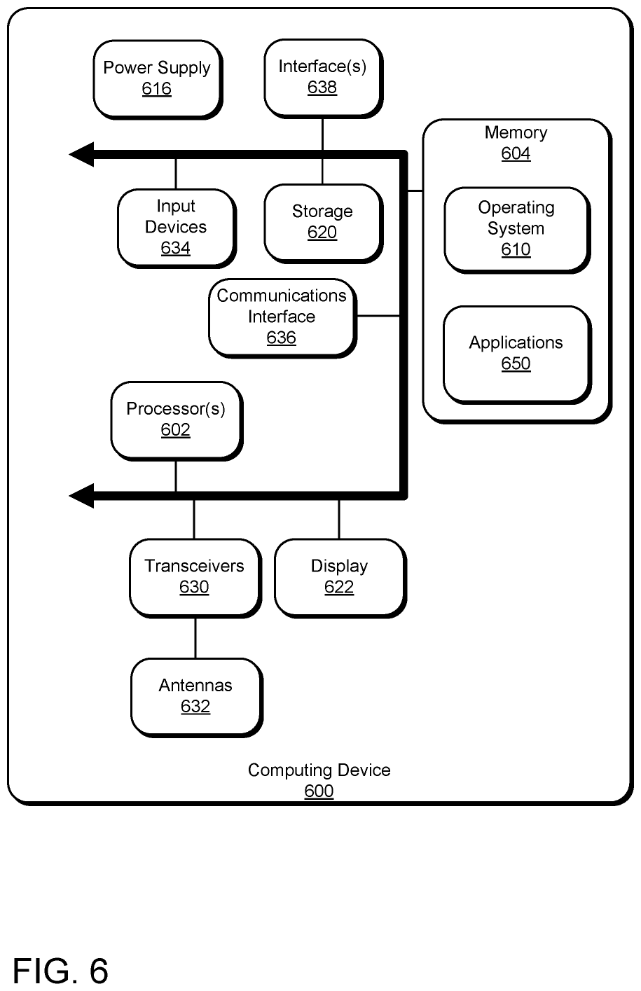

FIG. 6 illustrates an example computing device 600 for use in implementing the described technology. The computing device 600 may be a client computing device (such as a laptop computer, a desktop computer, or a tablet computer), a server/cloud computing device, an Internet-of-Things (IoT), any other type of computing device, or a combination of these options. The computing device 600 includes one or more processor(s) 602 and a memory 604. The memory 604 generally includes both volatile memory (e.g., RAM) and nonvolatile memory (e.g., flash memory), although one or the other type of memory may be omitted. An operating system 610 resides in the memory 604 and is executed by the processor(s) 602. In some implementations, the computing device 600 includes and/or is communicatively coupled to storage 620.

In the example computing device 600, as shown in FIG. 6, one or more modules or segments, such as applications 650, a search engine, a phonemic indexer, an approximate match analyzer, a phonetic converter, a score conditioner, a neural phonemic translation machine learning model, and other program code and modules are loaded into the operating system 610 on the memory 604 and/or the storage 620 and executed by the processor(s) 602. The storage 620 may store a search query, an input token, a phonetic representation, a phonemic index, an inverted index database, approximate matching scores (e.g., maximal phonetic sequence scores or MPS scores), orthography-agnostic search results, phonemic variants, language IDs, record IDs, and other data and be local to the computing device 600 or may be remote and communicatively connected to the computing device 600. In particular, in one implementation, components of a system for searching an inverted index database for an input token of a search query may be implemented entirely in hardware or in a combination of hardware circuitry and software.

The computing device 600 includes a power supply 616, which may include or be connected to one or more batteries or other power sources, and which provides power to other components of the computing device 600. The power supply 616 may also be connected to an external power source that overrides or recharges the built-in batteries or other power sources.

The computing device 600 may include one or more communication transceivers 630, which may be connected to one or more antenna(s) 632 to provide network connectivity (e.g., mobile phone network, Wi-Fi®, Bluetooth®) to one or more other servers, client devices, IoT devices, and other computing and communications devices. The computing device 600 may further include a communications interface 636 (such as a network adapter or an I/O port, which are types of communication devices). The computing device 600 may use the adapter and any other types of communication devices for establishing connections over a wide-area network (WAN) or local-area network (LAN). It should be appreciated that the network connections shown are exemplary and that other communications devices and means for establishing a communications link between the computing device 600 and other devices may be used.

The computing device 600 may include one or more input devices 634 such that a user may enter commands and information (e.g., a keyboard, trackpad, or mouse). These and other input devices may be coupled to the server by one or more interfaces 638, such as a serial port interface, parallel port, or universal serial bus (USB). The computing device 600 may further include a display 622, such as a touchscreen display.

The computing device 600 may include a variety of tangible processor-readable storage media and intangible processor-readable communication signals. Tangible processor-readable storage can be embodied by any available media that can be accessed by the computing device 600 and can include both volatile and nonvolatile storage media and removable and non-removable storage media. Tangible processor-readable storage media excludes intangible communications signals (such as signals per se) and includes volatile and nonvolatile, removable and non-removable storage media implemented in any method or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 600. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A method of searching an inverted index database for an input token of a search query, the method comprising: generating a phonemic index for the input token; executing an approximate matching analysis on content tokens of the inverted index database based on the phonemic index for the input token, wherein the inverted index database includes a first inverted index corresponding to phonemic indices of the content tokens and to a first orthography and a second inverted index corresponding to phonemic variants of the content tokens and to a second orthography; and returning one or more search results based on the approximate matching analysis.

Clause 2. The method of clause 1, wherein executing the approximate matching analysis comprises: comparing phoneme embeddings corresponding to each phoneme for the input token to phoneme embeddings for each phoneme of each content token; and generating a score for each content token based on per-phoneme similarity analysis with the input token, wherein the score represents a combination of measurements of similarity between phoneme embeddings corresponding to each phoneme of the input token compared to phoneme embeddings for each corresponding phoneme of each content token.

Clause 3. The method of clause 1, further comprising: generating a phonemic index for a first content token corresponding to the first orthography; and adding the phonemic index for the first content token in the first orthography to an inverted index corresponding to the first orthography in the inverted index database.

Clause 4. The method of clause 1, further comprising: generating a phonemic variant of a first content token corresponding to the second orthography using a neural phonemic translation machine learning model trained using phonemic index pairs corresponding to different orthographies.

Clause 5. The method of clause 4, wherein the generating further comprises: biasing the phonemic variant of the first content token toward pronunciation of the second orthography.

Clause 6. The method of clause 1, further comprising: generating the phonemic index for a phonemic variant of a first content token corresponding to the second orthography; and adding the phonemic index for the first content token corresponding to the second orthography to an inverted index corresponding to the second orthography in the inverted index database.

Clause 7. The method of clause 1, wherein generating the phonemic index for the input token comprises: converting the input token into a phonetic representation; and transcribing the phonetic representation of the input token into the phonemic index for the input token.

Clause 8. A computing system for searching an inverted index database for an input token of a search query, the computing system comprising: one or more hardware processors; a phonemic indexer executable by the one or more hardware processors and configured to generate a phonemic index for the input token; an approximate match analyzer executable by the one or more hardware processors and configured to execute an approximate matching analysis on content tokens of the inverted index database based on the phonemic index for the input token, wherein the inverted index database includes a first inverted index corresponding to phonemic indices of the content tokens and to a first orthography and a second inverted index corresponding to phonemic variants of the content tokens and to a second orthography; and a score conditioner executable by the one or more hardware processors and configured to return one or more search results based on the approximate matching analysis.

Clause 9. The computing system of clause 8, wherein the approximate match analyzer is further configured to: compare phoneme embeddings corresponding to each phoneme for the input token is compared to phoneme embeddings for each phoneme of each content token; and generate a score for each content token based on per-phoneme similarity analysis with the input token, wherein the score represents a combination of measurements of similarity between phoneme embeddings corresponding to each phoneme of the input token compared to phoneme embeddings for each corresponding phoneme of each content token.

Clause 10. The computing system of clause 8, wherein the phonemic indexer is further configured to generate a phonemic index for a first content token corresponding to the first orthography and to add the phonemic index for the first content token in the first orthography to an inverted index corresponding to the first orthography in the inverted index database.

Clause 11. The computing system of clause 8, further comprising: a neural phonemic translation machine learning model executable by the one or more hardware processors and configured to generate a phonemic variant of a first content token corresponding to the second orthography, wherein the neural phonemic translation machine learning model is trained using phonemic index pairs corresponding to different orthographies.

Clause 12. The computing system of clause 11, wherein the phonemic indexer is further configured to bias the phonemic variant of the first content token toward pronunciation of the second orthography.

Clause 13. The computing system of clause 8, wherein the phonemic indexer is further configured to generate the phonemic index for a phonemic variant of a first content token corresponding to the second orthography and to add the phonemic index for the first content token corresponding to the second orthography to an inverted index corresponding to the second orthography in the inverted index database.

Clause 14. The computing system of clause 8, further comprising: a phonetic converter executable by the one or more hardware processors and configured to convert the input token into a phonetic representation, wherein the phonemic indexer is further configured to transcribe the phonetic representation of the input token into the phonemic index for the input token.

Clause 15. One or more tangible processor-readable storage media embodied with instructions for executing on one or more processors and circuits of a computing device a process searching an inverted index database for an input token of a search query, the process comprising: generating a phonemic index for the input token; executing an approximate matching analysis on content tokens of the inverted index database based on the phonemic index for the input token, wherein the inverted index database includes a first inverted index corresponding to phonemic indices of the content tokens and to a first orthography and a second inverted index corresponding to phonemic variants of the content tokens and to a second orthography; and returning one or more search results based on the approximate matching analysis.

Clause 16. The one or more tangible processor-readable storage media of clause 15 wherein executing the approximate matching analysis comprises: comparing phoneme embeddings corresponding to each phoneme for the input token to a phoneme embeddings for each phoneme of each content token; and generating a score for each content token based on per-phoneme similarity analysis with the input token, wherein the score represents a combination of measurements of similarity between phoneme embeddings corresponding to each phoneme of the input token compared to phoneme embeddings for each corresponding phoneme of each content token.

Clause 17. The one or more tangible processor-readable storage media of clause 15, wherein the process further comprises: generating a phonemic index for a first content token corresponding to the first orthography; and adding the phonemic index for the first content token in the first orthography to an inverted index corresponding to the first orthography in the inverted index database.

Clause 18. The one or more tangible processor-readable storage media of clause 15, wherein the process further comprises: generating a phonemic variant of a first content token corresponding to the second orthography using a neural phonemic translation machine learning model trained using phonemic index pairs corresponding to different orthographies.

Clause 19. The one or more tangible processor-readable storage media of clause 18, wherein the generating comprises: biasing the phonemic variant of the first content token toward pronunciation of the second orthography.

Clause 20. The one or more tangible processor-readable storage media of clause 15, wherein the process further comprises: generating the phonemic index for a phonemic variant of a first content token corresponding to the second orthography; and adding the phonemic index for the first content token corresponding to the second orthography to an inverted index corresponding to the second orthography in the inverted index database.

Clause 21. A system of searching an inverted index database for an input token of a search query, the system comprising: means for generating a phonemic index for the input token; means for executing an approximate matching analysis on content tokens of the inverted index database based on the phonemic index for the input token, wherein the inverted index database includes a first inverted index corresponding to phonemic indices of the content tokens and to a first orthography and a second inverted index corresponding to phonemic variants of the content tokens and to a second orthography; and means for returning one or more search results based on the approximate matching analysis.

Clause 22. The system of clause 21, wherein means for executing the approximate matching analysis comprise: means for comparing phoneme embeddings corresponding to each phoneme for the input token to phoneme embeddings for each phoneme of each content token; and means for generating a score for each content token based on per-phoneme similarity analysis with the input token, wherein the score represents a combination of measurements of similarity between phoneme embeddings corresponding to each phoneme of the input token compared to phoneme embeddings for each corresponding phoneme of each content token.

Clause 23. The system of clause 21, further comprising: means for generating a phonemic index for a first content token corresponding to the first orthography; and means for adding the phonemic index for the first content token in the first orthography to an inverted index corresponding to the first orthography in the inverted index database.

Clause 24. The system of clause 21, further comprising: means for generating a phonemic variant of a first content token corresponding to the second orthography using a neural phonemic translation machine learning model trained using phonemic index pairs corresponding to different orthographies.

Clause 25. The system of clause 24, wherein the means for generating further comprise: means for biasing the phonemic variant of the first content token toward pronunciation of the second orthography.

Clause 26. The system of clause 21, further comprising: means for generating the phonemic index for a phonemic variant of a first content token corresponding to the second orthography; and means for adding the phonemic index for the first content token corresponding to the second orthography to an inverted index corresponding to the second orthography in the inverted index database.

Clause 27. The system of clause 21, wherein means for generating the phonemic index for the input token comprise: means for converting the input token into a phonetic representation; and means for transcribing the phonetic representation of the input token into the phonemic index for the input token.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method of searching an inverted index database for an input token of a search query, the method comprising:
generating a phonemic index for the input token;
executing an approximate matching analysis on content tokens of the inverted index database based on the phonemic index for the input token, wherein the inverted index database includes a first inverted index corresponding to phonemic indices of the content tokens and to a first orthography and a second inverted index corresponding to phonemic variants of the content tokens and to a second orthography; and
returning one or more search results based on the approximate matching analysis.

2. The method of claim 1, wherein executing the approximate matching analysis comprises:
comparing phoneme embeddings corresponding to each phoneme for the input token to phoneme embeddings for each phoneme of each content token; and
generating a score for each content token based on per-phoneme similarity analysis with the input token, wherein the score represents a combination of measurements of similarity between phoneme embeddings corresponding to each phoneme of the input token compared to phoneme embeddings for each corresponding phoneme of each content token.

3. The method of claim 1, further comprising:
generating a phonemic index for a first content token corresponding to the first orthography; and
adding the phonemic index for the first content token in the first orthography to an inverted index corresponding to the first orthography in the inverted index database.

4. The method of claim 1, further comprising:
generating a phonemic variant of a first content token corresponding to the second orthography using a neural phonemic translation machine learning model trained using phonemic index pairs corresponding to different orthographies.

5. The method of claim 4, wherein the generating further comprises:
biasing the phonemic variant of the first content token toward pronunciation of the second orthography.

6. The method of claim 1, further comprising:
generating the phonemic index for a phonemic variant of a first content token corresponding to the second orthography; and
adding the phonemic index for the first content token corresponding to the second orthography to an inverted index corresponding to the second orthography in the inverted index database.

7. The method of claim 1, wherein generating the phonemic index for the input token comprises:
converting the input token into a phonetic representation; and
transcribing the phonetic representation of the input token into the phonemic index for the input token.

8. A computing system for searching an inverted index database for an input token of a search query, the computing system comprising:
one or more hardware processors;
a phonemic indexer executable by the one or more hardware processors and configured to generate a phonemic index for the input token;
an approximate match analyzer executable by the one or more hardware processors and configured to execute an approximate matching analysis on content tokens of the inverted index database based on the phonemic index for the input token, wherein the inverted index database includes a first inverted index corresponding to phonemic indices of the content tokens and to a first orthography and a second inverted index corresponding to phonemic variants of the content tokens and to a second orthography; and
a score conditioner executable by the one or more hardware processors and configured to return one or more search results based on the approximate matching analysis.

9. The computing system of claim 8, wherein the approximate match analyzer is further configured to:
compare phoneme embeddings corresponding to each phoneme for the input token to phoneme embeddings for each phoneme of each content token; and
generate a score for each content token based on per-phoneme similarity analysis with the input token, wherein the score represents a combination of measurements of similarity between phoneme embeddings corresponding to each phoneme of the input token compared to phoneme embeddings for each corresponding phoneme of each content token.

10. The computing system of claim 8, wherein the phonemic indexer is further configured to generate a phonemic index for a first content token corresponding to the first orthography and to add the phonemic index for the first content token in the first orthography to an inverted index corresponding to the first orthography in the inverted index database.

11. The computing system of claim 8, further comprising:
a neural phonemic translation machine learning model executable by the one or more hardware processors and configured to generate a phonemic variant of a first content token corresponding to the second orthography, wherein the neural phonemic translation machine learning model is trained using phonemic index pairs corresponding to different orthographies.

12. The computing system of claim 11, wherein the phonemic indexer is further configured to bias the phonemic variant of the first content token toward pronunciation of the second orthography.

13. The computing system of claim 8, wherein the phonemic indexer is further configured to generate the phonemic index for a phonemic variant of a first content token corresponding to the second orthography and to add the phonemic index for the first content token corresponding to the second orthography to an inverted index corresponding to the second orthography in the inverted index database.

14. The computing system of claim 8, further comprising:
a phonetic converter executable by the one or more hardware processors and configured to convert the input token into a phonetic representation, wherein the phonemic indexer is further configured to transcribe the phonetic representation of the input token into the phonemic index for the input token.

15. One or more tangible processor-readable storage media embodied with instructions for executing on one or more processors and circuits of a computing device a process searching an inverted index database for an input token of a search query, the process comprising:
generating a phonemic index for the input token;
executing an approximate matching analysis on content tokens of the inverted index database based on the phonemic index for the input token, wherein the inverted index database includes a first inverted index corresponding to phonemic indices of the content tokens and to a first orthography and a second inverted index corresponding to phonemic variants of the content tokens and to a second orthography; and
returning one or more search results based on the approximate matching analysis.

16. The one or more tangible processor-readable storage media of claim 15 wherein executing the approximate matching analysis comprises:
comparing phoneme embeddings corresponding to each phoneme for the input token to phoneme embeddings for each phoneme of each content token; and
generating a score for each content token based on per-phoneme similarity analysis with the input token, wherein the score represents a combination of measurements of similarity between phoneme embeddings corresponding to each phoneme of the input token compared to phoneme embeddings for each corresponding phoneme of each content token.

17. The one or more tangible processor-readable storage media of claim 15, wherein the process further comprises:
generating a phonemic index for a first content token corresponding to the first orthography; and
adding the phonemic index for the first content token in the first orthography to an inverted index corresponding to the first orthography in the inverted index database.

18. The one or more tangible processor-readable storage media of claim 15, wherein the process further comprises:
generating a phonemic variant of a first content token corresponding to the second orthography using a neural phonemic translation machine learning model trained using phonemic index pairs corresponding to different orthographies.

19. The one or more tangible processor-readable storage media of claim 18, wherein the generating comprises:
biasing the phonemic variant of the first content token toward pronunciation of the second orthography.

20. The one or more tangible processor-readable storage media of claim 15, wherein the process further comprises:
generating the phonemic index for a phonemic variant of a first content token corresponding to the second orthography; and
adding the phonemic index for the first content token corresponding to the second orthography to an inverted index corresponding to the second orthography in the inverted index database.
